(19) United States
(12) Patent Application Publication
(10) Pub. No.: US 2009/0019008 A1
(43) Pub. Date: Jan. 15, 2009

(54) ONLINE SHOPPING SEARCH ENGINE FOR VEHICLE PARTS

(76) Inventors: Thomas J. Moore, Seal Beach, CA (US); William C. Kelley, Carson, CA (US); Andrew R. Wilson, Pasadena, CA (US)

Correspondence Address: KAUTH , POMEROY , PECK & BAILEY ,LLP, P.O. BOX 19152, IRVINE, CA, 92623, US

(21) Appl. No.: 12/111,141

(22) Filed: Apr. 28, 2008

Related U.S. Application Data
(60) Provisional application No. 60/914,641, filed on Apr. 27, 2007.
(60) Provisional application No. 60/914,639, filed on Apr. 27, 2007.

(51) Int. Cl. G06F 7/06; G06F 17/30

(52) U.S. Cl. 707/3; 707/E17.014

(57) ABSTRACT

Systems and methods for providing an online shopping search engine for vehicle specific products are described. One embodiment includes selecting a year, make, and model, selecting at least one product category, presenting at least one vehicle specific product based upon at least one query of a database using at least the year, make and model information, and the at least one product category, selecting one of the presented vehicle specific products, presenting a list of resellers, selecting one of the presented resellers, and performing a handoff to the website of the selected resellers. Typically, the database is a database of vehicle specific products identified based upon year, make, model fitment information and at least one product category.

### PRIORITY CLAIM

The current invention claims priority to U.S. Provisional Application No. 60/914,641, filed Apr. 27, 2007, and U.S. Provisional Application No. 60/914,639 filed Apr. 27, 2007, the disclosure of which is incorporated herein by reference in its entirety.

### FIELD OF THE INVENTION

The present invention relates generally to the field of search engines and more specifically to online shopping search engines for vehicle products and parts.

### BACKGROUND

Search engines are commonly used to locate information on the World Wide Web and in various databases of information. The difficulty in locating specific information using keywords (i.e. semantic search) has led to the development of a number of vertical search engines. Vertical search engines attempt to return search results only within a specific subject area or “vertical” in a more accurate fashion than their purely semantic counterparts. Vertical search engines typically utilize specialized knowledge and structured data of the vertical to return only relevant information.

A significant market exists for vehicle specific products (i.e. replacement parts, aftermarket parts, and vehicle accessories) for cars and other vehicles. Fitment is a significant concern when purchasing vehicle specific products. Fitment refers to the appropriateness of a particular product for a particular Year, Make, and Model (YMM) of vehicle and engine. A single product can be useful in a variety of vehicle YMM and engine applications. Vehicle specific products are manufactured by a vast array of manufacturers and distributed through a variety of resellers. Therefore, for a consumer, obtaining information concerning different product options can be difficult.

### SUMMARY OF THE INVENTION

Systems and methods are described for sourcing vehicle specific products. In a number of embodiments, a database is maintained of vehicle specific products, which includes specific attributes about the product and information concerning the vehicles and engines with which the product can be used. Searches of the database can be performed based upon a vehicle Year, Make, and Model (YMM), and optionally, upon an engine type (YMM/E). In several embodiments, the search query is provided by a user as freeform text and aliasing is used to map the freeform text to the structured data within the database. In many embodiments, the search results can be used to assist a user in locating and comparing (attributes, appearance, price, reviews, etc.) specific products of interest. Once a product has been identified, the database can identify resellers that stock the product and provide the user with links to reseller websites.

In several embodiments, the search results and selections performed by the user are used to identify relevant advertising to display along side the search results. In a number of embodiments, consumer selection of displayed advertising (click) is accompanied by a payment from the advertiser to the entity that maintains the database. In several embodiments, the search is performed via a syndicated site and the revenue from the advertiser is split between the syndicated site and the entity that maintains the database.

### BRIEF DESCRIPTION OF THE DRAWINGS

FIG. 1 is a schematic diagram of an online shopping engine for vehicle specific products in accordance with an embodiment of the invention.

FIG. 2 is a flow chart showing a process for sourcing a vehicle specific product in accordance with an embodiment of the invention.

FIG. 3 is a flow chart showing a process for sourcing a vehicle specific product and displaying advertising in accordance with an embodiment of the invention.

FIG. 4 is a partial screen shot of a portal site in which vehicle year, make, and model information can be entered.

FIG. 5 is a partial screen shot of the portal site shown in FIG. 4 in which vehicle information for a 2002 Subaru Impreza WRX has been entered in accordance with an embodiment of the invention.

FIG. 6 is a partial screen shot of the portal site shown in FIG. 5 in which the product category “Air Intake” has been entered by a user in accordance with an embodiment of the invention.

FIG. 7 is a partial screen shots of the portal site shown in FIG. 6 in which the product subcategory “Air Intake Systems” has been selected in accordance with an embodiment of the invention.

FIGS. 8a-8d are partial screen shots of the portal site shown in FIG. 7 in which the product “AEM—02-03 Impreza WRX” has been selected in accordance with an embodiment of the invention.

FIG. 9 is a flow chart showing a process for handing a user off from an online shopping engine to a reseller website in accordance with an embodiment of the invention.

FIG. 10 is a partial screen shot of a reseller website linked to by a user in accordance with an embodiment of the invention.

FIG. 11 is a flow chart showing a process for selecting contextually relevant advertisements for display in the user interface of an online shopping search engine for vehicle specific products in accordance with an embodiment of the invention.

FIG. 12 is a partial screen shot of a user interface of a syndicated website in accordance with an embodiment of the invention.

FIG. 13 is a partial screen shot of a user interface provided by an online shopping search engine on behalf of a syndicated website in accordance with an embodiment of the invention.

FIG. 14 is a screen shot of report showing part/manufacturer information not included in the database of an online shopping search engine, where the part/manufacturer information is prioritized based upon the popularity of the part/manufacturer, in accordance with an embodiment of the invention.

### DETAILED DESCRIPTION OF THE INVENTION

Turning now to the drawings, online shopping engines for vehicle specific products are shown. The online shopping search engines enable users to identify and source products compatible with a specific vehicle and engine configuration. The online shopping search engines include a database in which information concerning vehicle specific products is stored. The term vehicle specific product is used to describe replacement parts, aftermarket parts, vehicle accessories and any other type of product that is designed for use with a particular subset of vehicles. In many embodiments, the information concerning vehicle specific products stored in the database is obtained from a variety of sources. The information concerning vehicle specific products typically includes fitment information, which enables users to search for vehicle specific products using vehicle/engine Year, Make and Model (YMM) information. Although reference is made to providing YMM information, many embodiments of the invention enabling searching based upon engine type in addition to YMM (i.e. YMM/E). Therefore, YMM/E searching can be used in any of the embodiments discussed below. The database also includes information concerning resellers that sell each of the vehicle specific products, which can be used to provide users with links to websites of resellers that stock a specific product of interest. The database can also be used to obtain information to assist a user with purchasing a selected vehicle specific product such as availability information, customer reviews, relevant performance attributes (i.e. weight, materials, horse power, etc.) and pricing information.

In many embodiments, access is provided to the database via portal sites or syndicated sites. In several embodiments, advertising is displayed that is contextually relevant to the selections made by a user interacting with the site. In many embodiments, the advertising can be in the form of banner advertisements and the site can register instances in which a visitor to the site links to an advertiser's site.

### System Architecture

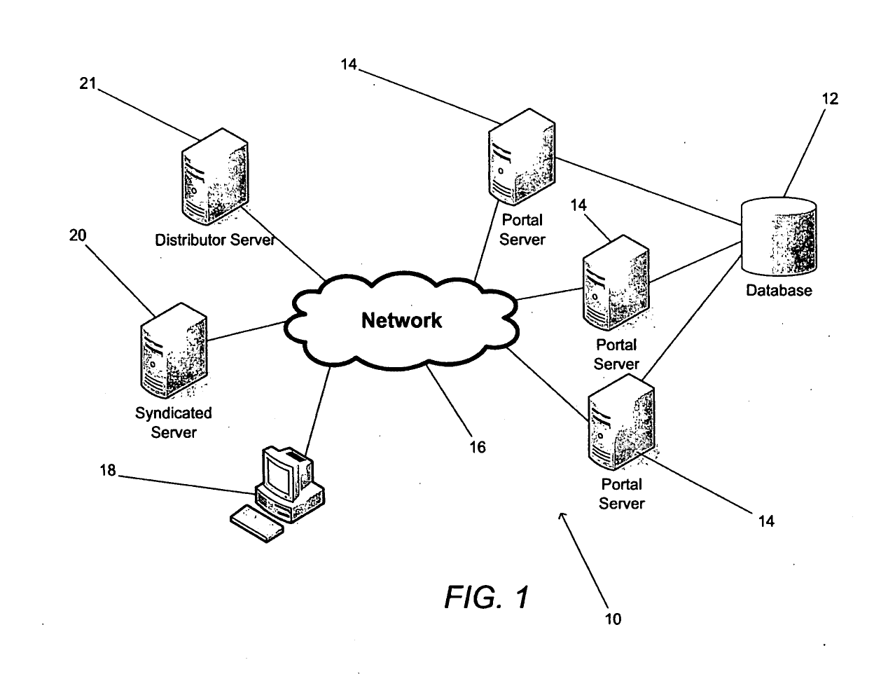

An online shopping search engine including a searchable database of vehicle specific products is shown in FIG. 1. The online shopping search engine 10 includes a database 12 containing information concerning vehicle specific products. The database is connected to a number of portal servers 14. The portal servers are connected to a network 16 and the portal servers 14 communicate with user devices 18 enabling users to search the database 12. The system also includes a number of syndicated servers 20. The syndicated servers 20 also enable users to search the database 12. One or more reseller servers 21 can also be connected to the network. The reseller servers host websites of resellers of vehicle specific products and typically provide e-commerce facilities to enable the purchase of a product.

As discussed above, the database 12 includes information concerning vehicle specific products. The vehicle specific product information can include a list of vehicle specific products and the vehicle/engine configurations with which the products can be used as well as product attributes relevant to a shopper making a specific product selection from a set of seemingly equivalent parts. In many embodiments, the vehicle/engine configurations are identified using YMM information. In several embodiments, information can be uploaded to the database from a variety of sources including manufacturers of vehicle specific products and organizations that provide cataloging services for vehicle specific products. In many embodiments, uploaded information is specified in accordance with the AAIA Catalog Enhanced Standard (ACES) developed by the Automotive Aftermarket Industry Association, which is based in Bethesda, Md. In a number of embodiments, cataloging software such as the SPEEDcat™ application distributed by Digital Performance, Inc. of Long Beach, Calif. can be used by manufacturers to enter aftermarket product information for uploading to a database 12. In other embodiments, software such as the software described in U.S. patent application Ser. No. 11/425,140 to Thomas Moore can be used to enter aftermarket product information and upload it to a database in accordance with embodiments of the invention. The disclosure of U.S. patent application Ser. No. 11/425,140 is incorporated by reference herein in its entirety.

In addition to listings of vehicle specific products and vehicles with which the products can be used, many databases in accordance with embodiments of the invention include information concerning resellers of a particular vehicle specific product. The listings of resellers for each product enable users to source particular products. Sourcing is the process of locating one or more resellers that can supply a product to a user. The user can then purchase the product from the reseller who may provide a product specific (SKU level) data feed which indicates that they stock such parts in inventory for sale. The database can also include listings of advertisers that wish to present advertising to users in response to a search involving a specific vehicle or product. In other embodiments, listings of resellers and of advertising are maintained in a separate database and are provided by an advertising server in response to user input.

In the illustrated embodiment, a number of portal servers 14 serve information to user devices 18 that enable users to search the database 12 or browse the database using a directory. The information served by the portal servers is typically related and can be viewed conceptually as a portal site. A portal site typically includes a user interface in which a user can specify a vehicle/engine YMM.

### Searching/Shopping for Products

The portal server 14 uses the vehicle/engine YMM information to submit a query to the database 12 seeking vehicle specific products that can be used in conjunction with the specified vehicle/engine YMM. In a number of embodiments, the database 12 responds to the query by returning a series of categories in the form of a directory. The user can make selections of categories and sub-categories from within the directory until a list of products of interest is located. The selection of a product of interest from the list by the user causes the portal server 14 to retrieve information concerning the product from the database 12 for display on the user device 18. In addition, the portal server 14 can retrieve information concerning resellers of the product from the database with URLs that enable the user to link to the specific product on a reseller's website. In many embodiments, the portal server 14 manages the handoff of the user from the portal site to the retail site of the reseller, which is typically maintained on a reseller server 21. In several embodiments, the handoff process includes mechanisms to detect whether the selection is being made by an automated system (e.g. a bot) instead of a legitimate user.

In many embodiments, the user is only ever provided with categories, sub-categories and products that are appropriate to the vehicle indicated in the initial YMM query. Each selection within a directory is provided to the database and the database provides a list of subcategories or vehicle specific products in response. In other embodiments, the portal server includes a standard directory and submits a query to the database when the user has provided vehicle YMM information and used the directory to specify a subcategory at the most granular level of the directory. The database 12 then returns a list of vehicle specific products in response to a query that includes YMM information and the subcategory information.

### Contextually Relevant Advertising

In many embodiments, the portal sites include advertising that is contextually relevant. Until YMM information is entered by a user, pages displayed to the user can include advertising generally of interest to users that visit the portal site or relevant to particular content displayed on the site. Once a vehicle YMM is selected, the displayed advertising is selected to relate to goods and services relevant to the particular vehicle YMM. As various categories of parts and subparts are selected, the advertising displayed can be relevant to the particular category and/or subcategory selected. Once a specific product is selected, information presented by the portal site concerning the product can be accompanied by advertising relevant to the specific product, articles concerning the product, and/or reviews of the product.

In a number of embodiments, the portal server 14 maintains records of the number of advertising impressions, and/or the number of instances of users clicking through advertising. These records can be used to charge advertisers for the placement of advertising. In many embodiments, affiliate agreements are entered into with advertisers, which obligate advertisers to pay a success fee in response to the occurrence of predetermined events. In several embodiments, the success fee can be calculated as a percentage of sales generated as a result of the advertising. In other embodiments, the success fee can be calculated based upon the occurrence of another type of user interaction with a site, such as a user registering to use a site.

In a number of embodiments, a server 14 or server bank (not shown) acts as an advertising server and supplies advertising to the portal servers 14 and syndicated servers 20. Use of an advertising server can simplify contracting for advertising services and billing for advertising services by providing a single source for advertisements for a network of sites. The advertising server 14 can provide an interface in which advertisers can indicate a willingness to pay for advertising in specific contexts. Examples of contexts include user selection of a particular vehicle YMM, user selection of a particular category or subcategory within a directory, or user selection of a specific part. In many embodiments, a user account can be maintained and information concerning the user's preferences used in the selection of advertising. In addition to providing opportunities to advertise, the advertising server can enable the provision of special offers relevant to a particular context. The advertising server can also provide useful information to vertical shopping tools. Such information can include customer ratings, product availability, relevant product attributes for product comparison purposes and price comparisons. In many embodiments, the portal servers and/or syndicated servers provide users with the opportunity to rate vehicle specific products and/or retailers listed within the database. The ratings can be collected by the advertising server and stored in the database. The advertising server can retrieve a summary of the customer ratings for a particular vehicle specific product and/or reseller from the database and provide the summary to a portal server and/or syndicated server. The summary can be provided to a user as an enhancement to an advertisement or as information to assist with shopping.

### User Devices

A user device can take any of a variety of forms. A user device can be a network connected personal computer, a cellular phone or a network enabled personal digital assistant (PDA). In other embodiments, any device capable of communicating with a portal server or syndicated server via the network can operate as a user device.

### Syndicated Online Shopping Networks

The syndicated servers 20 are servers that are capable of communicating information to one or more user devices via the network 16. The syndicated servers 20 are typically servers maintained by entities unrelated to the entity that maintains the database of vehicle specific products. The entities that maintain the syndicated servers typically contract with the entity that maintains the database of vehicle specific products to provide search services. In many embodiments, the entities that maintain the syndicated servers contract with the entity that maintains the database of vehicle specific products for provision of advertising. When advertising is provided, the entity that maintains the database provides a server 14 that handles the exchange of queries and search results between the syndicated server 20 and the database 12. The same server 14 (or another server) can act as an advertising server and provide the syndicated server 20 with advertisements. The advertising server 14 maintains records of the number of advertising impressions and/or instances of users clicking through advertising on the syndicated site. Revenues from advertisers in relation to the impressions and/or click throughs can be apportioned between the entity that maintains the syndicated server 20 and the entity that maintains the database 12 and advertising server 14 according to an agreement.

### Process for Purchasing Vehicle Specific Products

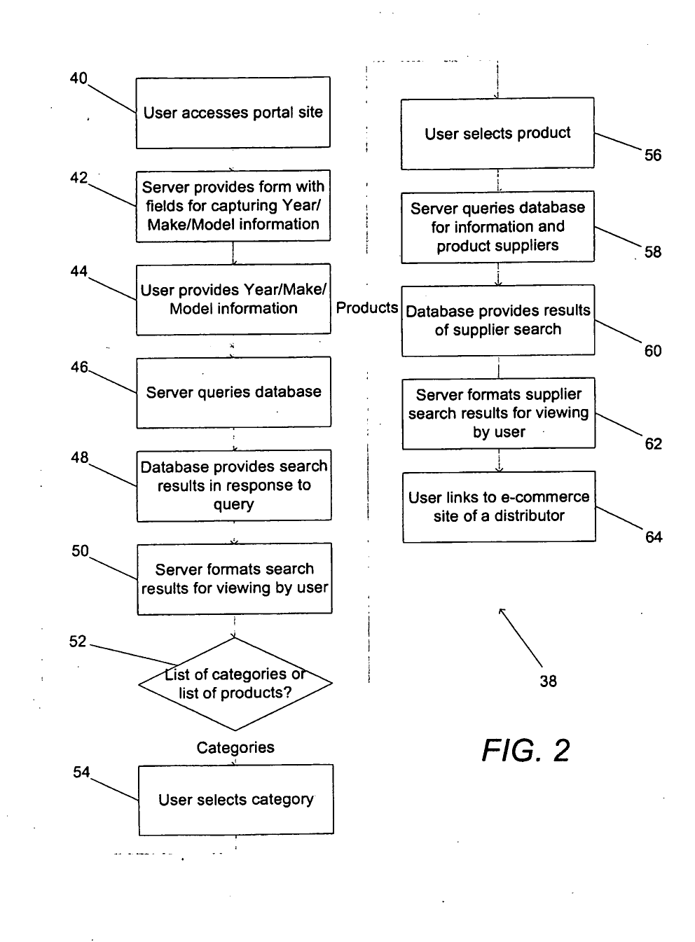

A process for sourcing an aftermarket product is shown in FIG. 2. Although the process references a portal site, a similar process can be used with syndicated sites. The process 38 commences when a user accesses (40) a portal site. The server provides (42) the user with a form that can be used to capture YMM information concerning a vehicle/engine configuration. The user enters (44) YMM information and the server queries (46) a database of vehicle specific products using the YMM information. In a number of embodiments, the YMM information that can be entered by a user is constrained. The database returns (48) a listing of aftermarket product categories, the server displays (50) the categories and the user can then select (54) a category of interest. In response to the user selection, the server then queries (52) the database again to provide information concerning the category of products. Depending upon the data within the database, the database can return (48) a number of product subcategories or a number of products that are then displayed (50) by the server. The user can continue to select subcategories until the database returns a list of vehicle specific products. When a list of vehicle specific products is provided by the database, the server (50) displays the list of vehicle specific products and the user can select (56) a product that is of interest. The server then queries (58) the database to obtain information concerning the selected product and, in many instances, a list of suppliers of the aftermarket product. In response to the query, the database returns (60) information concerning the product and a list of resellers. The server then formats the returned information and reseller search results for display (62) to the user. The user can then select (64) a reseller and link to the reseller's e-commerce site, where the user can purchase the product.

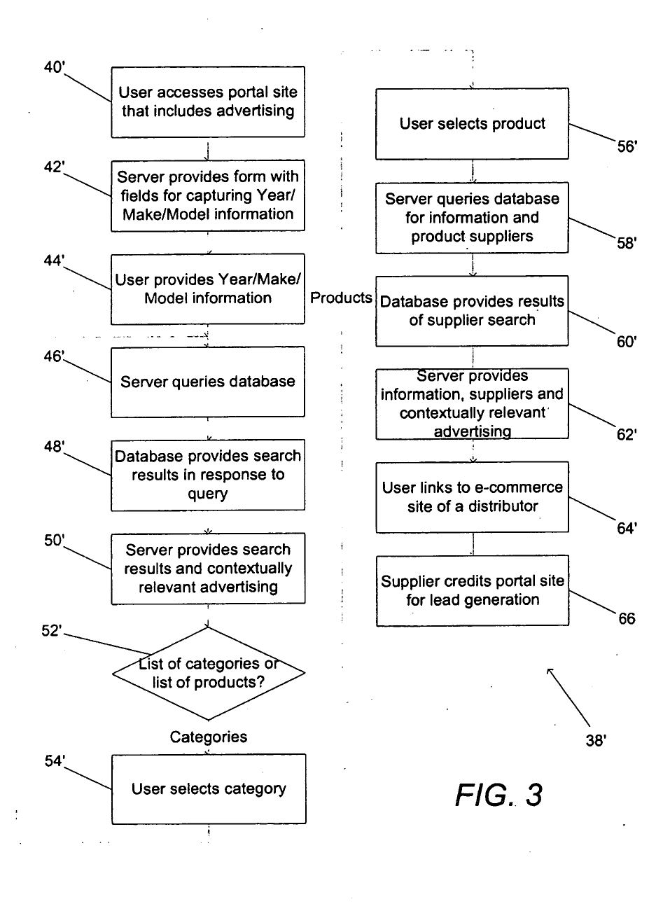

A process for sourcing an aftermarket product and for displaying contextually relevant advertising is shown in FIG. 3. Although the process references a portal site, a similar process can be used with syndicated sites. The process 38′ is similar to the process 38 shown in FIG. 2 with the exception that the server provides advertisements in combination with the database search results. When the user navigates to the portal site, the server provides (40′) initial advertising. The initial advertising can be in the form of banner advertising, hyper-link video clips, and/or other contextually relevant information. Advertising relevant to entered (46′) YMM information, a selected (54′) category or subcategory and/or a selected (56′) product is displayed in conjunction with search results and/or information returned by the database. In many embodiments, the database returns advertisements relevant to the search results in conjunction with the search results. When a user selects a product of interest, the server provides (62′) the user with a list of resellers for the selected product and contextually relevant advertising. In a number of embodiments, a user's decision to link to a reseller's web site results in the reseller crediting the portal site for the generation of a sales lead. In other embodiments, other arrangements can be developed for deriving revenue for advertising impressions and click throughs to advertisers' e-commerce sites.

### User Interfaces

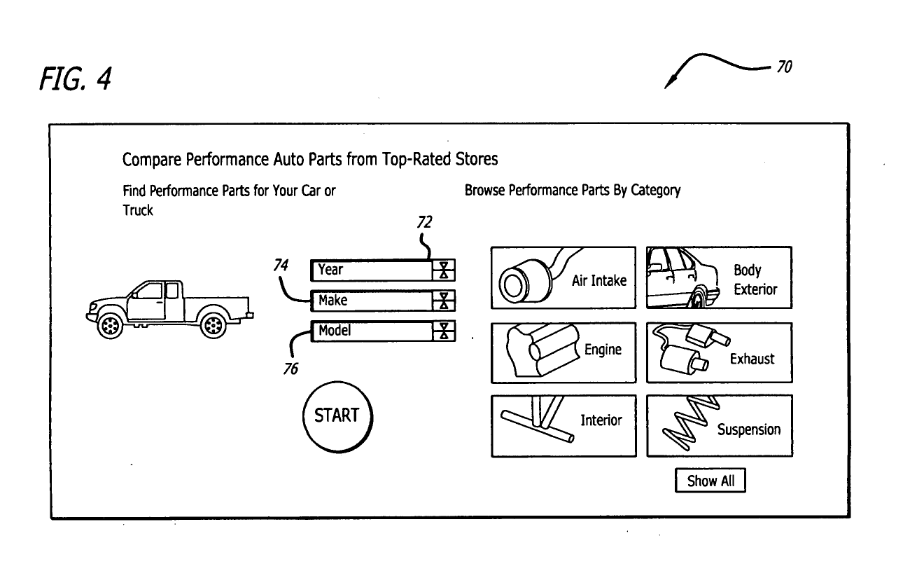

As discussed above, systems in accordance with embodiments of the invention enable users to source vehicle specific products. In a number of embodiments, the information displayed to the user is accompanied by contextually relevant advertising. A partial screen shot of a portal site in accordance with an embodiment of the invention is shown in FIG. 4. The user interface 70 includes three pull down menus. The pull down menus must each be accessed in sequence. The first pull down menu 72 specifies the vehicle year, the second pull down menu 74 specifies a vehicle make and the third pull down menu 76 specifies the vehicle model. The options in the second and third pull down menus are populated using information from the database based upon the selections from the preceding pull down menus. In other embodiments, a freeform search interface is provided. A user can enter a vehicle/engine configuration and/or product information into a freeform text box and the online shopping search engine can use aliasing to map the freeform text to structured data. The mapping to structured data enables the generation of subsequent user interfaces as though the vehicle/engine configuration and/or product had been captured as structured data.

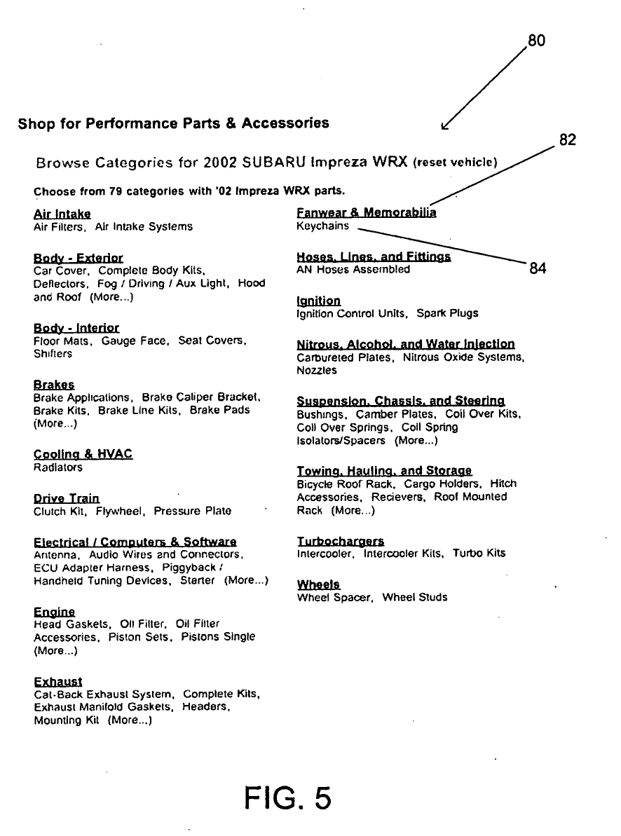

A partial screen shot of the same portal site in which YMM information for a 2002 Subaru Impreza WRX has been entered in accordance with an embodiment of the invention is shown in FIG. 5. The user interface 80 includes a directory of product categories 82 and sub-categories 84.

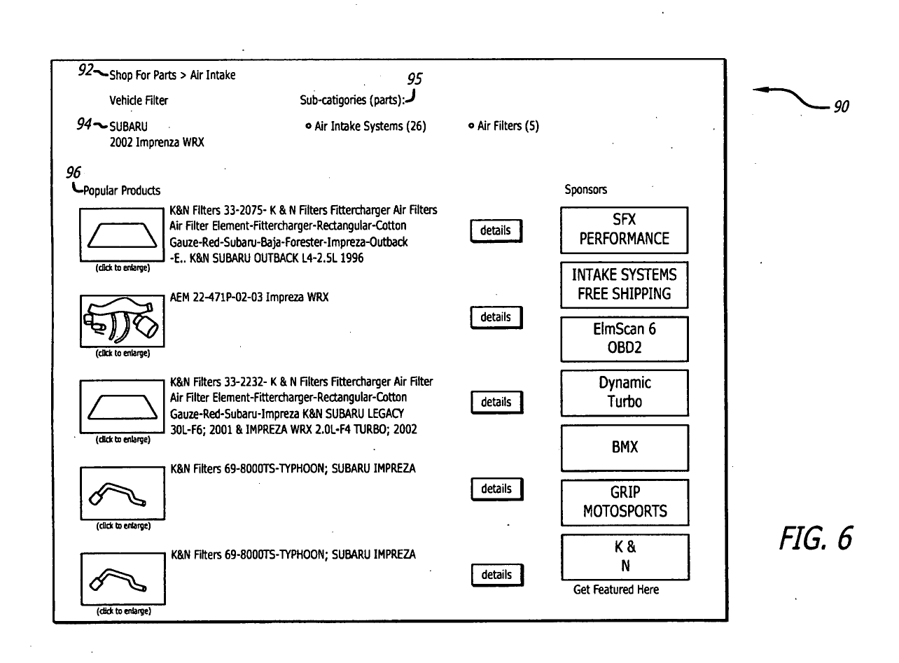

A partial screen shot of a page generated in response to the selection of the product category “Air Intake” is shown in FIG. 6. The user interface includes an indication of the user's location within the directory 92, the selected vehicle YMM 94, a list of subcategories 95, which includes two subcategories “Air Filters and Air Cleaners” and “Cold-Air and Short Ram Intake Systems”. In the illustrated embodiment, a list of popular products within the category that are compatible with the selected vehicle/engine YMM 96 is also displayed.

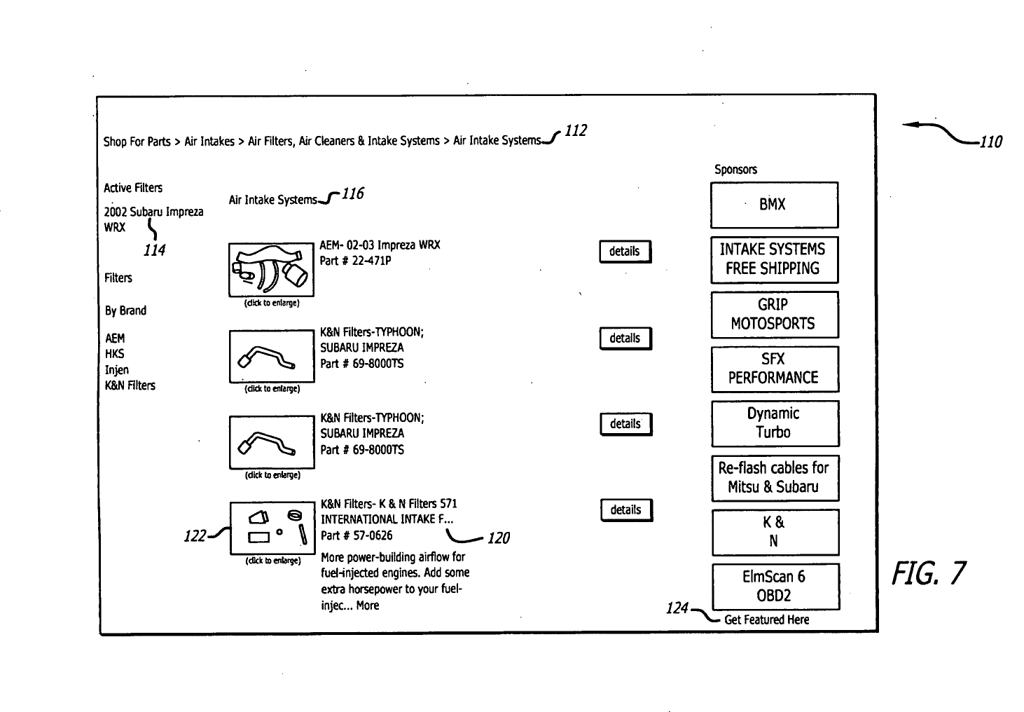

A partial screen shot of a web page generated in response to the selection of the “Cold-Air and Short Ram Intake Systems” subcategory in accordance with an embodiment of the invention is shown in FIG. 7. The user interface 110 includes an indication of the user's location within the directory 112, the selected vehicle YMM 114, and a list of products 116 that fit the selected vehicle. The information concerning each part includes descriptive text 120 and a photograph 122 (where available). Advertisements 124 are also displayed adjacent the user interface. In many embodiments, the displayed advertisements are selected based upon directory location, vehicle selection, and/or the displayed products.

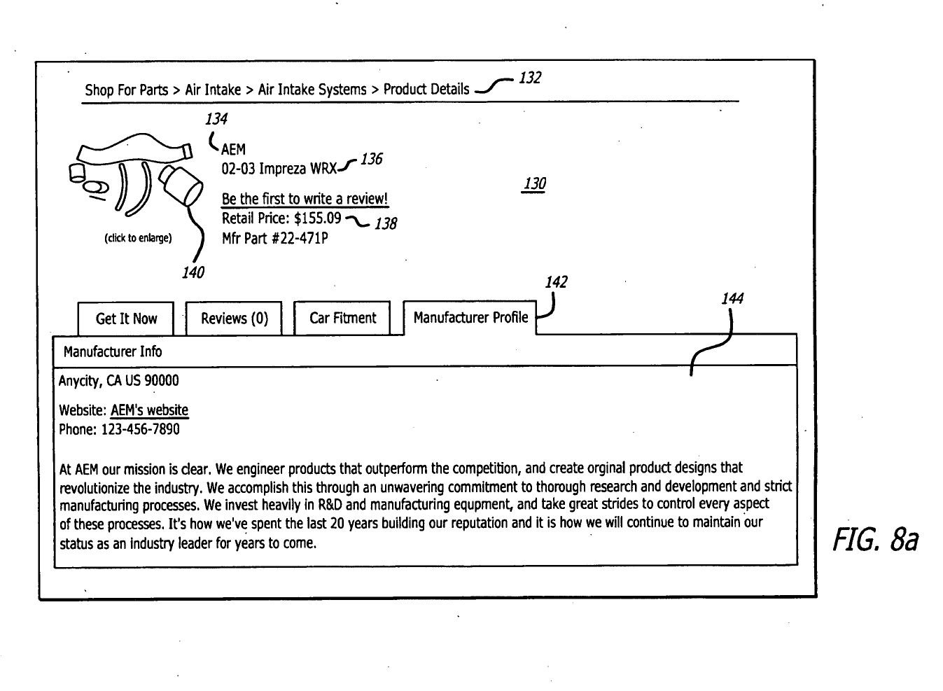

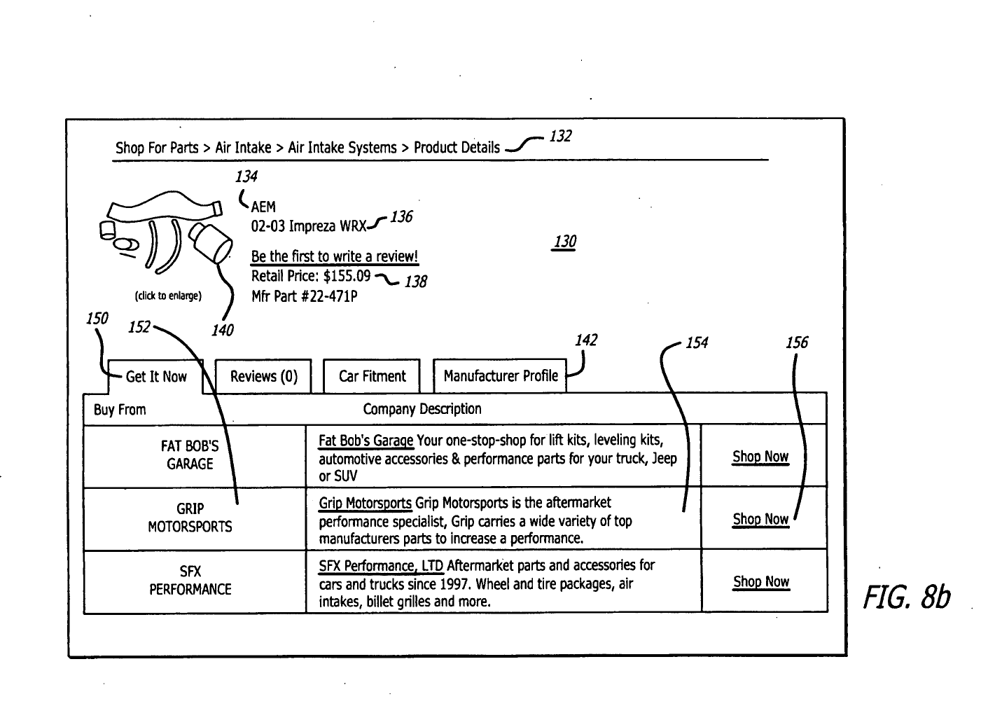

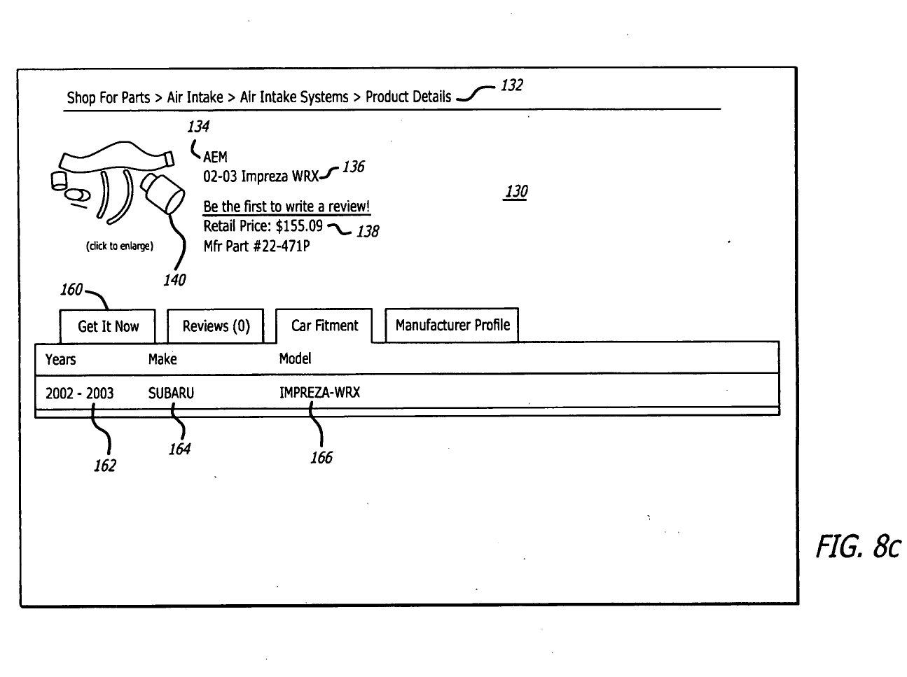

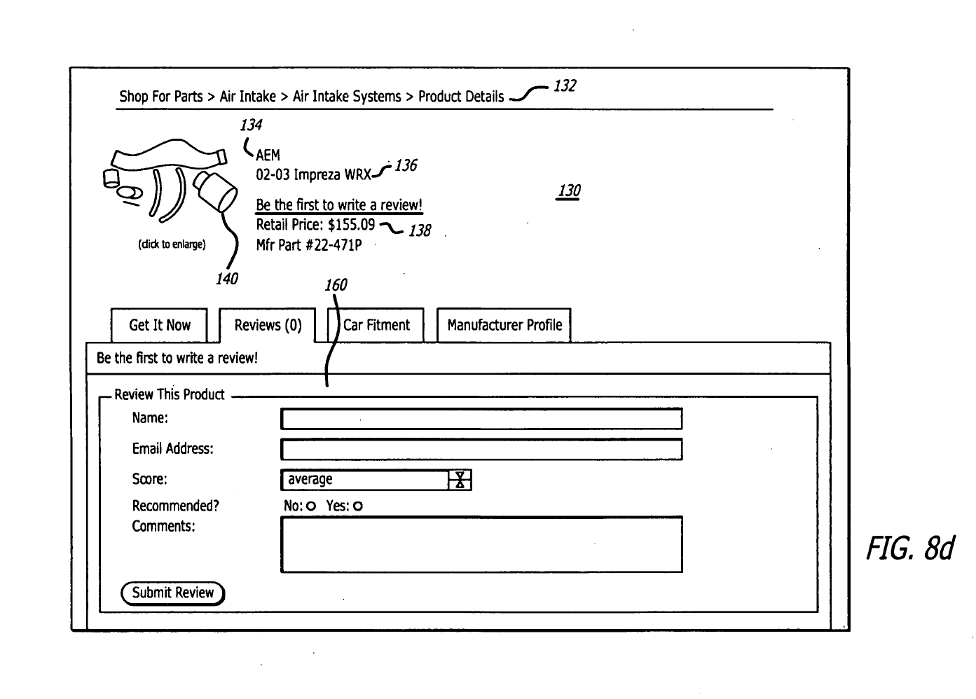

Partial screen shots of web page generated in response to the selection of the part “Cold Air Induction System 02-03 Subaru Impreza WRX” in accordance with an embodiment of the invention is shown in FIGS. 8a-8d. The user interface includes information concerning the location 132 of the user within the directory, the manufacturer 136 of the vehicle specific product, the recommended retail price of the product 138, a picture of the product, and a series of tabs. In the partial screen shot shown in FIG. 8a, the manufacturer profile tab is selected and information concerning the manufacturer 144 is displayed. In the partial screen shot shown in FIG. 8b, the “Get It Now” tab is selected and information concerning resellers that stock the part is displayed. The reseller information includes a reseller logo 152, a description of the reseller 154 and a link 156 that can be used to access the listing of the part within the reseller's website. In the partial screen shot shown in FIG. 8c, the car fitment tab is selected and information concerning the vehicle/engine configuration with which the part is compatible is displayed. The fitment information is expressed in terms of years 162, makes 154 and models 166 of vehicle/engine configurations with which the part is compatible. In the illustrated embodiment, the selected product is shown as being compatible with a 2002 or 2003 Subaru Impreza WRX. In the partial screen shot shown in FIG. 8d, the “Reviews” tab is selected. The reviews tab provides the user with a form 160 that can be used to write a review of the product. Although specific examples of user interfaces are discussed above, many variations of user interfaces can be used that involve populating the user interface with data retrieved from a database of vehicle specific products related by YMM fitment information in response to user input received in response to a previous user interface screen.

### Hand-Off to Reseller Websites

When a user selects a vehicle specific product using an online shopping search engine in accordance with an embodiment of the invention, the shopping search engine can provide the user with information concerning resellers that are able to sell the user the selected product. In many embodiments, the user interface provides the user with an option to link to the website of one or more resellers. When the user accepts the option to link to the website of a reseller, a hand-off process occurs between the online shopping search engine and the reseller's website. As part of the hand-off process, the online shopping search engine can attempt to detect selections that are not associated with the actions of user, but are rather associated with the actions of an automated process. The actions of the automated process are not likely to generate a sale (i.e., possibleclick fraud), therefore, the process attempts to detect selections made by automated processes to ensure that resellers are not charged for the selections. In many embodiments, the online shopping search engine detects robots (i.e., automated scripts) and filter out selections from the robots. In addition, unusual activity is tracked (e.g., hundreds of clicks from an IP address in a short space of time) and the reseller is credited for selections associated with the unusual activity. In several embodiments, the firewall of the online shopping search engine blocks IP addresses associated with robots and/or unusual activity.

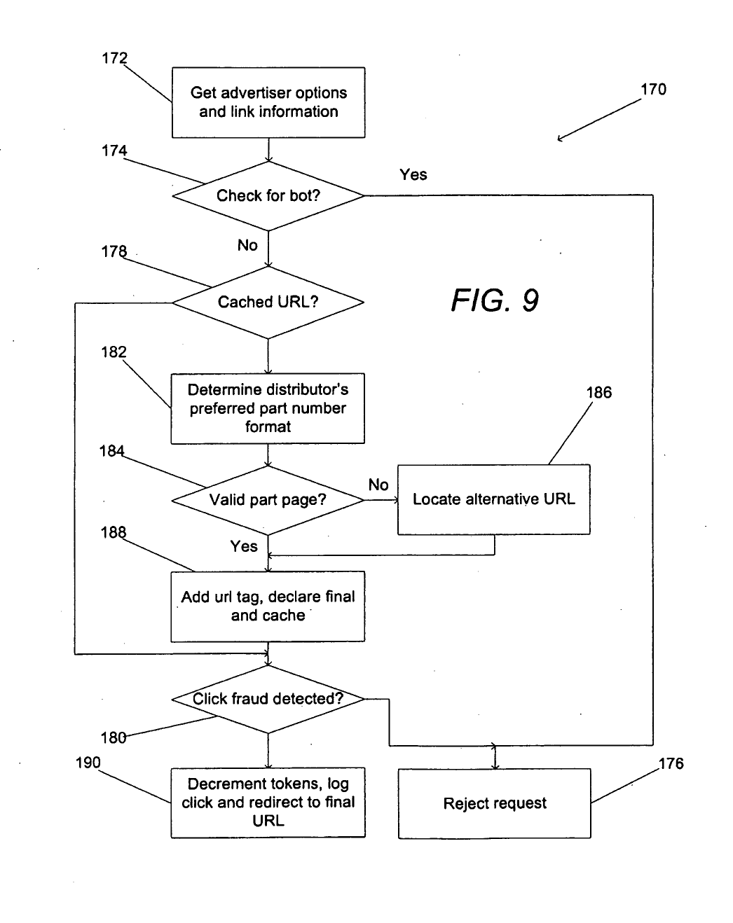

An embodiment of a process for handing off a user from an online shopping search engine to a reseller's website in accordance with an embodiment of the invention is shown in FIG. 9. The process 170 includes obtaining (172) reseller options for the selected vehicle specific product. When a reseller is selected, the process checks (174) to determine whether the selection was made by a user or an automated process such as a robot. When an automated process is detected, the request to link to the reseller's website is denied (176). When a legitimate user is detected, the process checks (178) to see whether a URL for the vehicle specific product (SKU level matching) is cached and proceeds to check (180) for unusual behavior (see discussion below). When a URL is not cached, then the reseller's preferred part number format is determined (182) and knowledge of the reseller's website is used to attempt to access a valid URL for the selected vehicle specific product on the reseller's website. A valid URL is a specific URL related to the product a reseller wants associated to that product. Use of a valid URL can be considered an “optimal” hand-off, because the URL gives a user a direct connection from the selected vehicle specific product to a page from which the product can be purchased on the reseller's website. In a number of embodiments, resellers provide the online shopping search engine with a list of all of the vehicle specific products that they carry and the corresponding URL on their site. When a list is provided, the list can be reviewed prior to determining the reseller's preferred part number format. When a determination (184) is made that the part number did not yield a valid part page, then the process attempts to locate and alternative page within the reseller's website to present to the user. In many embodiments, the page is located by first performing a search of product specific links provided by the reseller (SKU level) to locate and exact match; if that doesn't produce a valid result then a broad search within the reseller's web site product search for the product. If the product cannot be located, then an attempt is made to locate a page for the product's manufacturer (brand level search). In the event that the above searches are unsuccessful, then the user is provided with the URL for the landing page of the reseller's website.

Once a valid URL has been obtained, the process adds (188) a URL tag, which is appended alphanumeric information uniquely identifying the online shopping search engine as the source of the URL link, declares the URL the final URL and caches the final URL. Caching the URL reduces the processing required to achieve handoff the next time the vehicle specific product/reseller handoff occurs. A determination (180) is made as to whether the selection of the reseller was part of a pattern of unusual behavior, which is typically indicated by an unusually high number of selections within a predetermined period of time emanating from a single IP address or other behavior indicative of an automated process. When unusual behavior is detected, the request is rejected (176) and to the extent that a reseller had been charged a referral fee in association with the selection, the fee is refunded. When the request is legitimate, the process accounts (190) for the revenue generated by the sales lead provided to the reseller, logs the click and redirects the user's browser to the final URL. Although a specific handoff process is described above, other handoff processes can be used that enable the transfer of the user to a reseller's website in a manner that limits the referral fees paid by the reseller for selections made by robots and/or other automated processes.

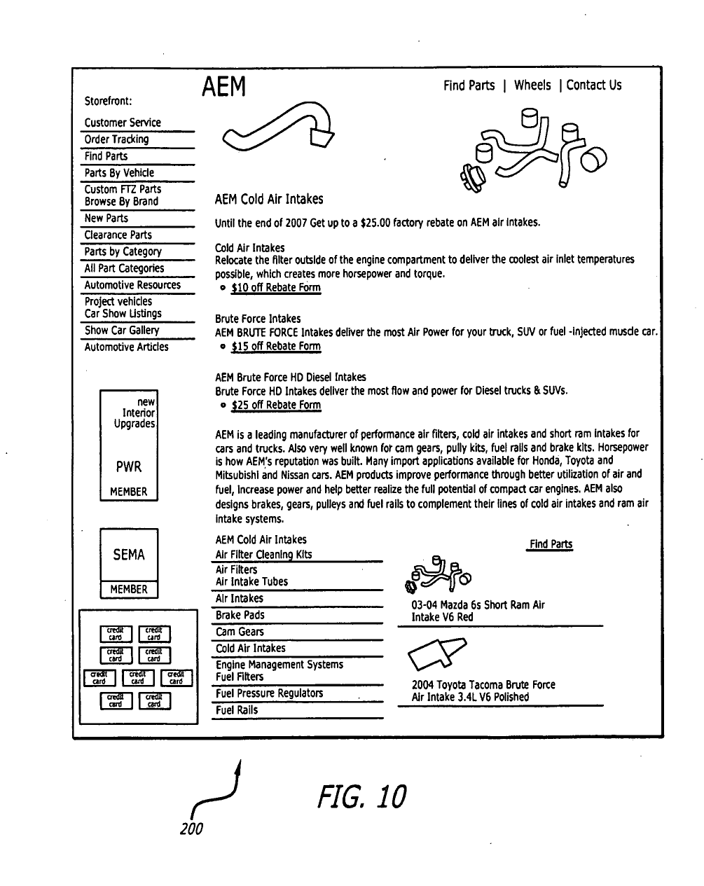

A partial screen shot of a product page of a reseller's website in accordance with an embodiment of the invention is shown in FIG. 10. The product page 200 includes information concerning the vehicle specific product.

### Selection of Advertisements

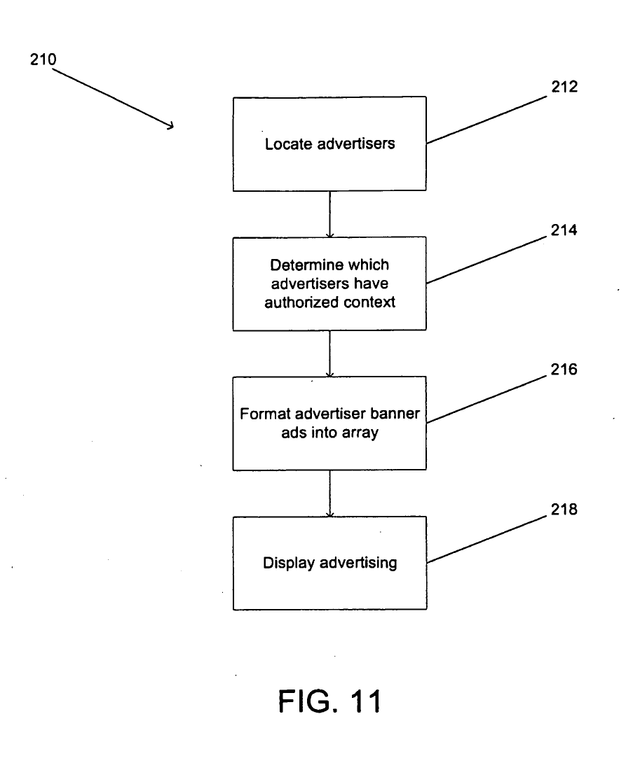

Online shopping search engines in accordance with embodiments of the invention possess the ability to select advertisers based upon various selections made by the user, during the user's search to locate a vehicle specific product. A process for selecting contextually relevant advertising in accordance with an embodiment of the invention is shown in FIG. 11. The process 210 includes retrieving (212) a list of advertisers, and determining (214) which advertisers have selected to be matched with the specific context. In many embodiments, advertisers are able to select categories, subcategories, brands and/or specific products with which they wish to associate their advertisements. In addition to context, advertisers can be selected based upon economic factors such as the amount that each advertiser is willing to pay for a click through or an impression. In a number of embodiments, the selection of contextually relevant advertising is facilitated by the structured nature of the data being searched by the online shopping search engine. Advertisers can specifically identify structures within the data such as categories, subcategories, brands, and/or vehicle specific products. Therefore, an advertiser can be certain of the specific contexts in which advertising is displayed.

When advertisers have been selected, the advertisements of the advertisers are formatted (216) for display. In many embodiments, the advertisements are banner advertisements that are formatted into an array for display (218) as part of the user interface of the online shopping search engine. Although specific processes for selecting contextually relevant advertising are outlined above, other processes in accordance with embodiments of the invention can be used to select advertising that is relevant to a specific context including selection of video advertisements, and/or contextually relevant articles, and/or product reviews.

### Syndication

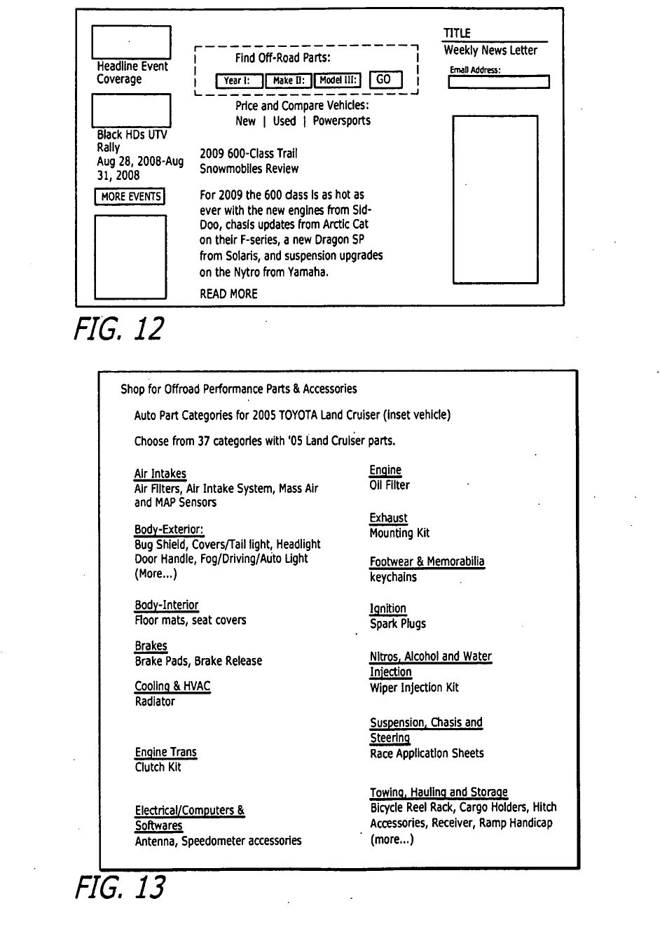

An online shopping search engine for vehicle specific products can be syndicated to servers maintained by third parties. In a number of embodiments, the syndicated server includes an iFrame containing a user interface provided by the online shopping search engine that enables selection of vehicle YMM information. Once selections have been made, the third party server hands the user off to the online shopping search engine. In many embodiments, the online shopping search engine is branded with third party's brand using a skin to give the user a seamless experience (i.e. the user believes that all functions are being performed by a single server). A partial screen shot of a third party website including an iFrame including a user interface provided by an online shopping search engine in accordance with an embodiment of the invention is shown in FIG. 12. A partial screen shot of a page provided by an online shopping search engine to a user handed off to an online shopping search engine by a syndicated server is shown in FIG. 13.

### Prioritizing Data Entry

In a number of embodiments, vehicle specific product information is obtained from a number of sources. In many embodiments, a portion of the data is automatically provided by publishing software used by manufacturers to catalog their vehicle specific products and another portion is manually added to the online shopping search engine's database of vehicle specific products. In a number of embodiments, a variety of techniques are used to identify and prioritize data entry of vehicle specific products that are not included in the database. In several embodiments, resellers provide streams showing parts that are not included in the database that are being purchased via the reseller's website. Based on the reseller streams a report can be composed showing brands and/or vehicle specific products that are not present—or for which data is incompletely classified—in the database that are ranked based upon the frequency with which they are being searched for/purchased on reseller websites.

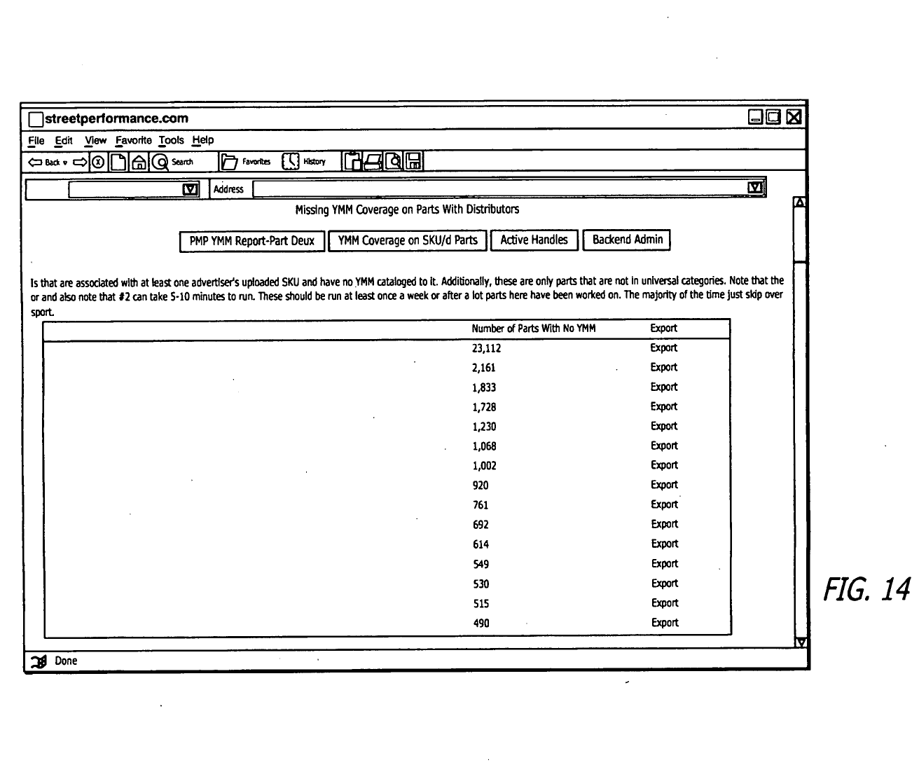

A screen shot of a report showing parts that are not completely classified in the database arranged by manufacturer and the number of parts is shown in FIG. 14. In other embodiments, other reports can be generated based upon information provided by resellers. Examples of such reports include reports that prioritize the vehicle specific parts that require full cataloging (i.e. with vehicle, pictures, category and description) based on data sent from resellers.

Although the discussion above assumes that a user will commence a search by providing a vehicle/engine YMM to restrict the products displayed by a portal or syndicated site, embodiments of the invention enable a user to navigate a general directory and provide YMM information at any point. In many embodiments, a user can navigate to a particular product and then enter YMM information to ascertain whether the product is suitable for fitment on a particular YMM or vehicle/engine configuration. Alternatively, the portal site can include content from which YMM information is extracted and the YMM used to provide contextually relevant advertising to the portal site.

Content from which YMM information can be extracted includes articles, product reviews and user generated content such as a blog or profile. In a number of embodiments, a web crawler (also known as an intelligent agent or software robot) is used to identify information on websites that can be matched to a vehicle/engine YMM. Such a crawler can be used to facilitate gathering of information for inclusion in the database 12 or for providing for searching of the web or a website to obtain information relevant to a specific vehicle/engine YMM.

Tables used in a database in accordance with an embodiment of the invention are attached as Appendix A. The arrows show relationships between data in each of the tables.

While the above description contains many specific embodiments of the invention, these should not be construed as limitations on the scope of the invention, but rather as an example of one embodiment thereof. For example, considerable reference is made to automobiles. However, systems and methods in accordance with embodiments of the invention can be used to source vehicle specific products and provide relevant advertising with respect to motorcycles, boats, bicycles, motor homes, airplanes and other types of vehicles. Furthermore, the nature of a portal site or syndicated site should not be limited to sites that provide information in the form of web pages. In many embodiments, information can be provided as a Wireless Application Protocol (WAP) interface to a cellular device or using any other suitable protocol for interactively exchanging information. Accordingly, the scope of the invention should be determined not by the embodiments illustrated, but by the appended claims and their equivalents.

What is claimed is:

1. A method for locating vehicle specific products using a database of vehicle specific products identified by year, make, and model and by product category, comprising:
selecting a year, make, and model;
selecting at least one product category;
presenting at least one vehicle specific product based upon at least one query of the database that uses at least the selected year, make, and model information, and the selected product category;
selecting one of the presented vehicle specific products;
presenting reseller information associated with the selected vehicle specific product in the database;
selecting one of the presented resellers;
performing a handoff to the website of the selected reseller; and
recording information associated with the handoff event.
